(19) United States
(12) Patent Application Publication
(10) Pub. No.: US 2004/0226887 A1
(43) Pub. Date: Nov. 18, 2004

(54) High percentage recovery method for purifying microemulsions

(75) Inventors: Nandakishore Rajagopalan, Champaign, IL (US); Todd Rusk, Champaign, IL (US)

Correspondence Address: GREER, BURNS & CRAIN, 300 S WACKER DR, 25TH FLOOR, CHICAGO, IL, 60606, US

(73) Assignee: The Board of Trustees of the University of Illinois

(21) Appl. No.: 10/438,739

(22) Filed: May 15, 2003

(51) Int. Cl. B01D 61/00

(52) U.S. Cl. 210/649; 210/739; 210/741; 210/791

(57) ABSTRACT

The invention is directed to purifying semi-synthetics, and may be conducted off-line or on line with a metal working process. In accordance with the invention, a tangential filter flow path for the microemulsions is provided to tangentially pass through a membrane filter sized to permit passage of microemulsions but inhibit passage of contaminants. The microemulsions are maintained in a tangential flow through the membrane filter with tangential flow velocity in the range of 1 m/s-7 m/s. A low filtering pressure is maintained in the range of 0.05-0.7 bar.

### FIELD OF THE INVENTION

The field of the invention is the metal products and machinery industry. The invention concerns metal working processes, and is particularly directed to the high percentage recovery of microemulsions, i.e., semi-synthetics used in metal working processes.

### BACKGROUND OF THE INVENTION

Modern high speed machining would not be possible without the use of metalworking fluids. Metalworking fluids provide cooling, lubrication, metal chip evacuation and short-term corrosion protection. The machining of any metal part typically involves the use of a metal working fluid.

Metalworking fluids can be divided into four basic categories: straight oils, soluble oils, semi-synthetics, and synthetics. In industry, semi-synthetics have become more and more popular. Metal working fluids are manufactured annually in an amount that was approximately 90 million gallons in the year 1998, and an upward trend in the production of the fluids has been indicated. Manufacture of the semi-synthetics accounted for about 24% of the metal working fluid manufacture in 1998 and was increasing.

Metalworking fluids are a major source of oily-wastewater in the effluents of industries in the metal products and machinery sector. It is estimated that about 1-2 Billion US gallons of oily wastewater results annually from the use of metal working fluids. This is a serious environmental issue, and is serious expense for the metal products and machinery sector.

During use, metal working fluids become process effluents when the level of contaminants, such as extraneous oil, particulate debris from machining operations, and bacterial growth, reach a critical threshold value that negatively impacts their functionality. Acquisition, management, and disposal costs are increasing. It has been estimated that for each dollar of metal working fluid concentrate purchased, up to eleven dollars are spent mixing, managing, treating and disposing of the metalworking fluids. It has also been estimated that metal working use and management contributes to about 12% of all machining costs, in an industry where tool costs are high and highly skilled labor is also a significant expense.

Increased attention is also now paid to the potential for contaminated metalworking fluids to have a negative impact on persons working in the metal products and machinery sector. A specific growing concern relates to possible exposure to pathogenic bacteria that may survive in the metalworking fluid sumps, including the possibility of allergenic reactions from exposure. There is also concern of the long term exposure risks associated with the use and handling of biocides.

One way to reduce both expense and health risks is to purify the metalworking fluids. Conventionally, cartridge filtration, coalescers, and centrifugation are used to extending the working life of metalworking fluids and to reduce the health risks associated with the metal working fluids. These conventional techniques are limited, however, in their capability to remove particulate matter of less than 10 μm, emulsified oil extraneous to native emulsion (also called tramp oil) and bacterial contamination.

Biocides represent another conventional technique to limit the bacterial contamination of metalworking fluids. However, the use of biocides for bio control is limited due to potential for workers to have increased exposure to endotoxins. It is also limited by microbial adaptation, as the biocides can become ineffective.

Membrane filtration of metalworking fluids has been considered. Most efforts have focused on removing all oil components from the solution. Removing all of the oils provides a partial solution to the disposal of spent metalworking fluids. However, recovery of the metalworking fluids is not addressed by such techniques.

Recovery presents a difficult issue, but if successful would substantially prolong the life of metal working fluids, while reducing environmental and health concerns. Recovery requires separating extraneous oil emulsion while allowing substantial transmission of native oil microemulsion. Additionally, the abundance of surface active components in the semi-synthetic metalworking fluid formulations increases membrane-solute interaction, which leads to severe membrane fouling and loss of native microemulsion.

A system for the recovery of microemulsions is described in U.S. Pat. No. 4,865,742. The patent describes the use of microfiltration for treating polluted oil-in-water emulsions or microemulsions. The patent states that a microfiltration membrane having a pore size of 0.2 μm-15 μm can be used, with a tangential flow velocity of between 1 m/s and 4 m/s, and a hydraulic pressure of between 1-5 bars. The present inventors have determined that at least substantial percentages of contaminants will pass through the filters under the conditions specified in U.S. Pat. No. 4,865,742. The conditions in U.S. Pat. No. 4,865,742 are such that fine emulsified extraneous oil, a contaminant, is unlikely to be separated. Accordingly, purification of the microemulsions is not achieved.

There remains a need for a demonstrably successful method for purifying microemulsions. At a minimum, a successful method should recover at least 50% of the microemulsions, and preferably recovers close to 100% of the microemulsions.

### SUMMARY OF THE INVENTION

The invention is directed to purifying semi-synthetics, and may be conducted on line or off-line with a metal working process. In accordance with the invention, a tangential filter flow path for the microemulsions is provided to tangentially pass a membrane filter sized to permit passage of microemulsions but inhibit passage of contaminants. The microemulsions are maintained in a tangential flow through the membrane filter with tangential flow velocity in the range of 1 m/s-7 m/s. A low filtering pressure is maintained in the range of 0.05-0.7 bar.

### BRIEF DESCRIPTION OF THE DRAWINGS

FIG. 1 shows an experimental filtration flow system of the invention;

FIG. 2 plots the transmittance as measured by refractive index and the membrane flux for an experimental run carried out for purifying semi-synthetic microemulsions;

FIG. 3 plots another experimental run carried out under the same conditions as in FIG. 2;

FIG. 4A plots an experimental run that used hard water for preparing the semi-synthetic microemulsions;

FIG. 4B plots another experimental run using hard water over a longer period;

FIG. 5 plots an experimental run including hydraulic oil contamination;

FIG. 6A plots an experimental run including a different level of hydraulic oil contamination;

FIG. 6B plots the effect of pressure and cross flow velocity upon the transmission of native microemulsions in a regenerated membrane as observed in a number of runs in the presence of hydraulic oil contamination;

FIG. 7A plots data from experiments testing for removal of Pseudomonas;

FIG. 7B plots data from additional experiments testing for removal of Pseudomonas;

FIGS. 8A and 8B plot data from additional experiments testing for removal of Pseudomonas;

FIG. 9 is a run time plot of the data from the experiments characterized in FIGS. 8A and 7A;

FIGS. 10A and 10B present endotoxin data of the feed and permeate at select points of the FIGS. 7A and 8A runs;

FIGS. 11A and 11B show runs that demonstrate the effect of strong base and acid membrane cleaning; and

FIG. 12 shows data demonstrating a membrane regeneration aspect of the invention.

### DETAILED DESCRIPTION OF THE PREFERRED EMDODIMENTS

This invention is a method for purifying semi-synthetic microemulsions such as those used in metal working from other contaminants such as free and emulsified hydraulic and way lube oil as well as particulate, bacteria, and bacterial toxins. The present invention can be applied to the recovery of any semi-synthetic microemulsion. A semi-synthetic microemulsion is defined as an emulsion having an average particle size less than 0.1 μm. The process can be done in a continuous mode or a batch mode for purification.

The semi-synthetic metal working fluid is separated from the other contaminants by filtering under low pressure the emulsion through a microporous membrane. The microporous membrane is selected so as to allow filtration of the semi-synthetic microemulsion while retaining the free and emulsified hydraulic oil, particulate, bacteria and bacterial toxins. A high productivity and separation selectivity is maintained through controlling both the surface state of the membrane as well as the operational conditions. Active monitoring and control is preferred to maintain filtering pressure.

Microfiltration offers the potential to remove both very fine particulate matter and microbial contamination simultaneously while minimizing the release of endotoxins. The use of microfiltration for microbial control also opens up the possibility of either eliminating the use or substantially reducing the use of biocides. The filtered coolant can be recycled back to the process reducing the waste volumes generated.

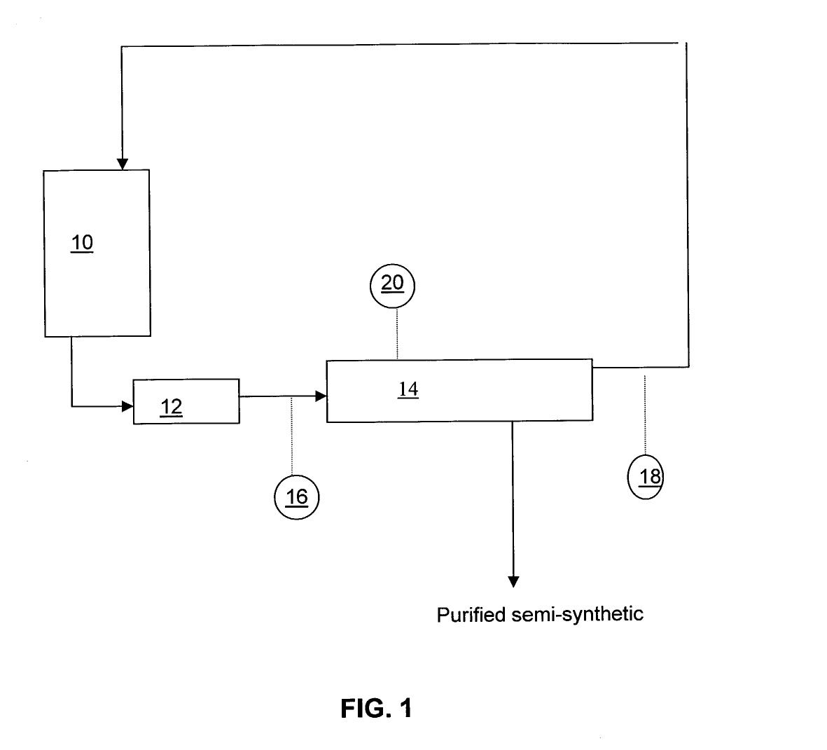

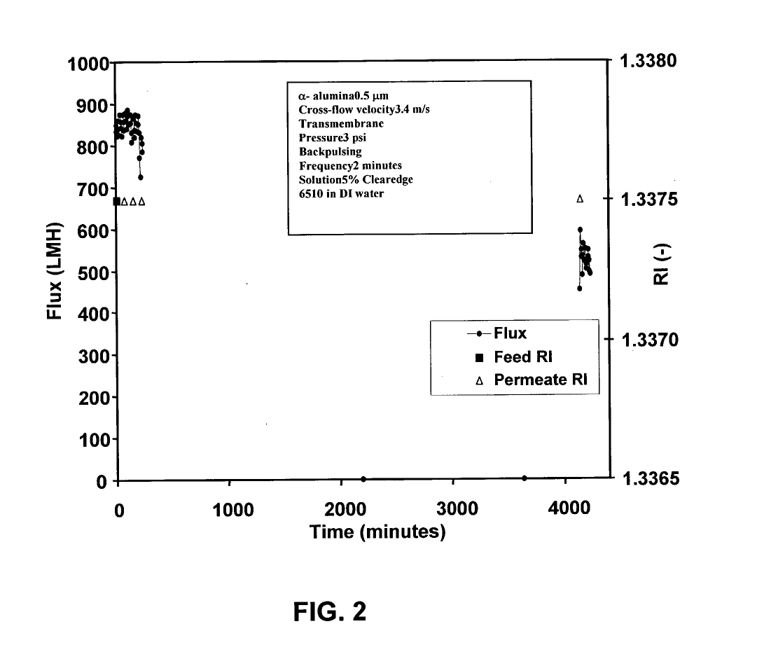

Preferred embodiment methods of the invention may be practiced in existing filtration devices. Any tangential flow (also known as cross-flow) configuration that permits back pulsing is suitable for practice of these embodiments of the present invention. The exemplary flow configuration of the device shown in FIGS. 1 and 2 of U.S. Pat. No. 4,865,742 is a suitable example of a tangential flow configuration that permits back pulsing. The invention sets process conditions to achieve a successful high percentage recovery of microemulsions. Other embodiments of the invention utilize a modified tangential flow configuration permitting active control of the pressure in a filtration module. Preferred embodiments use a valve at the outlet of the tangential filtration module to introduce back pressure during filtering to actively keep the filtering pressure in a necessary low pressure range. In additional embodiments, a generally conventional flow configuration has the filter module length and diameter, and the pipe lengths and diameters, set to achieve the required low filtering pressure.

The critical operating conditions are low filtering pressure and high tangential flow velocity. Frequent back pulsing is necessary to maintain the filtration surface free of obstructions. Optimal membrane surface characteristics are preferably obtained through either modifying the surface with a cationic polymer or avoiding the use of harsh cleaning agents such as bases and acids.

The method of the present invention effects a high percentage recovery of valuable semi-synthetic microemulsions such as those used in machining from contaminated solutions. Microfiltration membranes are employed to affect the separation of the semi-synthetic microemulsions from contaminants such as free and emulsified hydraulic oils, particulates, bacteria, and bacterial toxins. The contaminated semi-synthetic microemulsion is forced under pressure to flow through the barrier that selectively separates the contaminants while allowing near quantitative transmission of the semi-synthetic microemulsion.

An important aspect of preferred embodiment methods is the ability to control fouling of the membrane and allow for substantial recovery of the semi-synthetic microemulsion for reuse in machining. Membranes used in embodiments of the invention are microporous membranes. The membrane is comprised of a thin porous structure of appropriate pore-size that acts as the selective barrier. Such a barrier can either be an integral or a composite structure. In either case, the selective barrier is preferably thin to minimize pressure drop. The underlying support structure, whether integral or not is preferably of a pore-size that achieves the desired filtration, but also provides for free unhindered flow to prevent pressure build up. The membrane material can be any suitable material such as alumina, titania, or other ceramic, metallic or polymeric materials as known in the art. The key requirements are that the membrane be of the appropriate pore-size, in a configuration suitable for back pulsing. Membranes are also preferably hydrophilic. The pore-size of the membrane suitable for use with the invention is in a range from 0.05-1 μm.

The method in accordance with the invention is preferably performed at temperatures between 15 and 40° C., though higher temperatures are not precluded. The preferred temperature range is selected to promote energy conservation. The upper temperature limit permitted without regard to energy conservation is the temperature that can be tolerated by the semi-synthetic microemulsion without destabilization.

The filtering pressure is from 0.05-0.7 bar and preferably between 0.1-0.7 bars. The tangential flow rate is between 1 m/s and 7 m/s with a preferred range of 3-6 m/s. Field testing (without back pulsing) indicated that the recovery of microemulsions would be at unacceptable levels past 0.7 bars. Within the preferred ranges of filtering pressure, pore size and tangential flow velocity, it is possible to achieve near 100% recovery of micoemulsions. At pressures exceeding 0.7 bar, on the other hand, higher velocities are found necessary to maintain higher recoveries. Velocities higher than 7 m/s are problematic from an implementation standpoint. Membrane fouling is not an impediment to implementation of the present invention despite the low pressures, but continuous operation will require a back pulse regimen.

For such a continuous microemulsion purifying and recovering operation, the filtering membrane is back pulsed regularly at frequencies of 1 back pulse/min to 1 back pulse/45 minutes, with a preferred back pulsing frequency of 1 back pulse/2 minutes. The duration of the back pulse can vary from 1 second to 30 seconds, with the preferred value being 1 s. These operating conditions were identified because of their ability to minimize fouling.

If an improper cleaning is conducted, filtering membranes can become fouled. In the event of fouling, it has been found that treatment of the membrane with a cationic polymer such as Busan 77 followed by activation by sodium hydroxide (2% @ 70 C) and nitric acid (2% @ 70 C) effectively restores the performance of the membrane. Thus, fouled membranes may effectively be regenerated.

The invention has been demonstrated experimentally. FIG. 1 shows a filtration flow system used to conduct experiments to demonstrate the invention. The flow system included a vessel 10 to receive contaminated semi-synthetic microemulsion, a pump 12 for transferring the solution to a tangential membrane filter unit 14, a flow rate controller 16 for controlling the flow rate of the semi-synthetic microemulsion through the tangential filter unit 14, a pressure controller 18 for controlling filtering pressure, and a back pulse generator 20 for back pulsing the filter. The pressure controller 18 actively monitors and controls the filtering pressure.

Maintaining the filtering pressure is preferably achieved by controlling of the output of the tangential filter unit. The pressure controller 18 may include, for example, a throttle valve at the outlet of the tangential filter unit 14 to apply back pressure during filtration. Since it is desired that the bulk of the pressure drop occur at this point, it is important to minimize pressure drop elsewhere in the system and especially from the pump 12 to the tangential filter unit 14 inlet. The diameter of pipes between the pump 12 and tangential filter unit 14 inlet should be large enough to permit the filter pressure drop to be controlled within the desired low pressure range by the selective application of back pressure during filtration.

Maintaining the tangential flow rate is preferably achieved by controlling pump output. Reciprocating, gear and centrifugal pumps are exemplary suitable pumps. In the case of a gear pump, this is usually accomplished by varying the rpm of the gears.

For the purpose of further illustration of the invention, experimental results will now be discussed. The results demonstrate preferred aspects of the invention, and will be appreciated by artisans to demonstrate the efficacy of the invention. Artisans will also appreciate that results do not limit broader aspects of the invention as discussed above.

Experimental Results

The tangential filter unit 14 utilized for the experiments discussed below included membranes having a 0.5 μm pore-size and made of α-alumina and had the characteristics detailed in Table 1.

TABLE 1
Membrane characteristics

| | |
|---|---|
| Membrane type | α-alumina |
| Membrane diameter | 7 mm (nominal) |
| Membrane length | 25 cm (nominal) |
| Membrane pore-size | 0.5 μm |

The specific membrane characteristics are mentioned so that artisans will fully understand the experimental data, and the membrane characteristics accordingly only serve as an example and do not limit the invention. Other exemplary suitable membranes included regenerated cellulose, and poly(ether) sulfone.

In the experiments, the semi-synthetic microemulsion used was manufactured by Castrol Industrial North America, Downers Grove, Ill. and sold under the name Clear edge 6510. The particle size of this emulsion is found to be 30 nm from photon correlation spectroscopy. The transmittance of the microemulsion is measured by refractive index (RI) measurements. If the refractive index of the filtrate is close to that of the feed, complete transmittance is indicated. Typically, the semi-synthetic microemulsion concentrate was diluted to 5% (w/w), a typical concentration used in industry.

A set of experimental results are represented in FIG. 2. The conditions for the data obtained in FIG. 2 were as follows: α-alumina 0.5 μm, Cross-flow velocity 3.4 n/s, transmembrane pressure 3 psi, back pulsing frequency 2 minutes, and a solution 5% Clearedge 6510 in DI water. The water flux of the membrane prior to metal working fluid processing was found to be 1200 Liters/sq.m. membrane area/hour (LMH). FIG. 2 details a semi-synthetic metal working fluid (SSMWF) run on this membrane. Typically, a 4 L batch of SSMWF was used for each run and about 1 L of permeate would be collected before being recycled back to the feed tank. Each data point represents the average permeate production over a 5 minute interval. As seen, the MWF flux starts at about 900 LMH and gradually drops to about 500 LMH over a 70 hour time period. The refractive index (RI) of permeate is the same as that of feed, indicating complete transmittance. The membrane was cleaned with water alone.

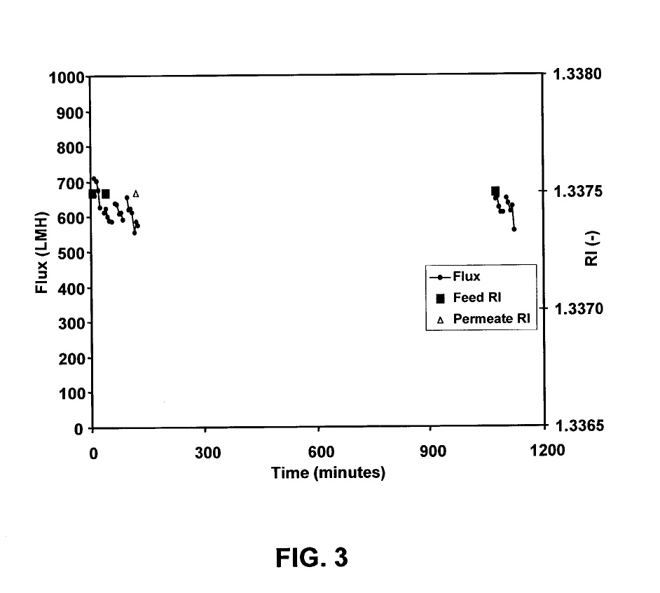

FIG. 3 is a graph of a second run using the FIG. 2 conditions. FIG. 3 shows that flux again appears to stabilize around 550 LMH over a 16 hour period while maintaining complete emulsion transmittance.

For the data in FIGS. 2 and 3, the microemulsions were made with 5% concentration in DI water. We also checked whether emulsion in tap water would have an adverse effect on microfiltration. The tap water used was from the City of Champaign, Ill. This water is not hard. No difference in metal working fluid flux was noticed due to make-up in tap water.

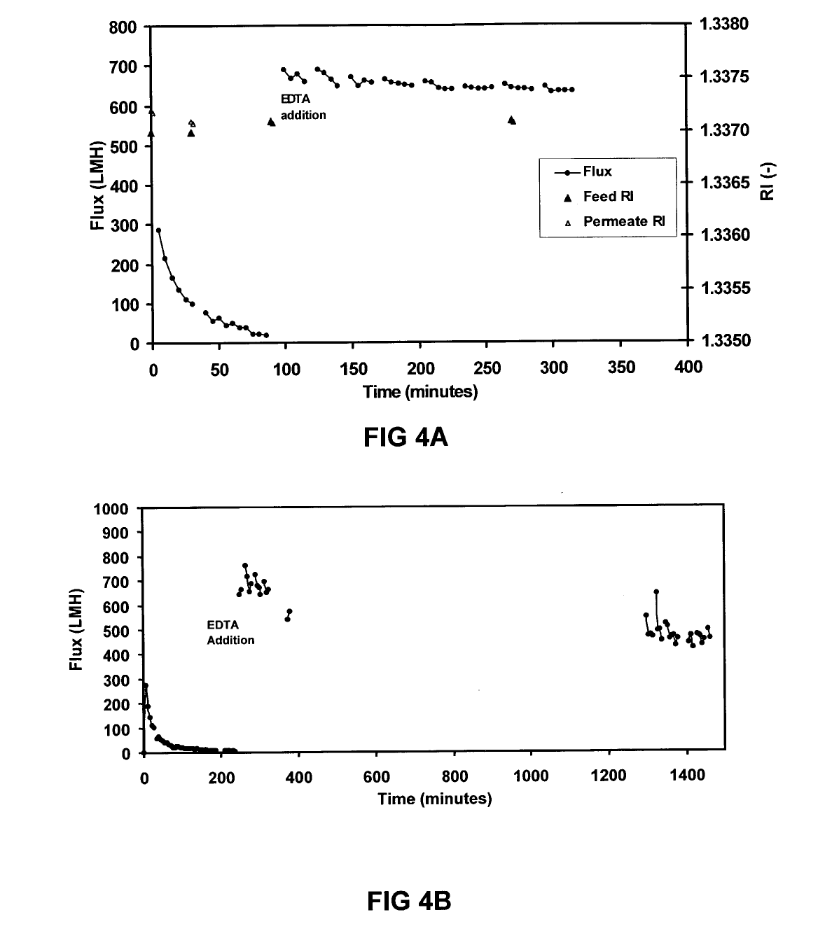

In practice, there can be a considerable difference in the hardness of water used for making up metal working fluid. For this reason, we also decided to check specifically for the effect of hardness on metal working fluid flux. Calcium chloride dihydrate (CaCl₂.2H₂O) was used as the source of Calcium. SSMWF was made up in water containing 97 ppm Calcium. The flux of the SSMWF dropped from about 300 LMH to less than 50 LMH, as shown in FIG. 4A. The FIG. 4A conditions are otherwise the same as in FIGS. 2 and 3.

After the drop to 50 LMH, a calcium chelant (EDTA) was introduced to sequester the calcium. The flux immediately recovered to levels as high as 700 LMH. A subsequent longer term experiment is represented in FIG. 4B, and confirmed that a calcium chelant could offset the effect of hard water, and showed that the SSMWF flux slowly decreased to 500 LMH, a value more typical for the metal working fluids. It is believed that the calcium acts as a bridge between the negatively charged membrane and the emulsion droplets allowing large clusters of emulsion droplets to form on the membrane surface. The introduction of EDTA disrupts these clusters by removing the calcium, opening the membrane pores, thereby increasing the flux in the short term. Thus, no irreversible fouling of the membrane is caused by ions such as calcium.

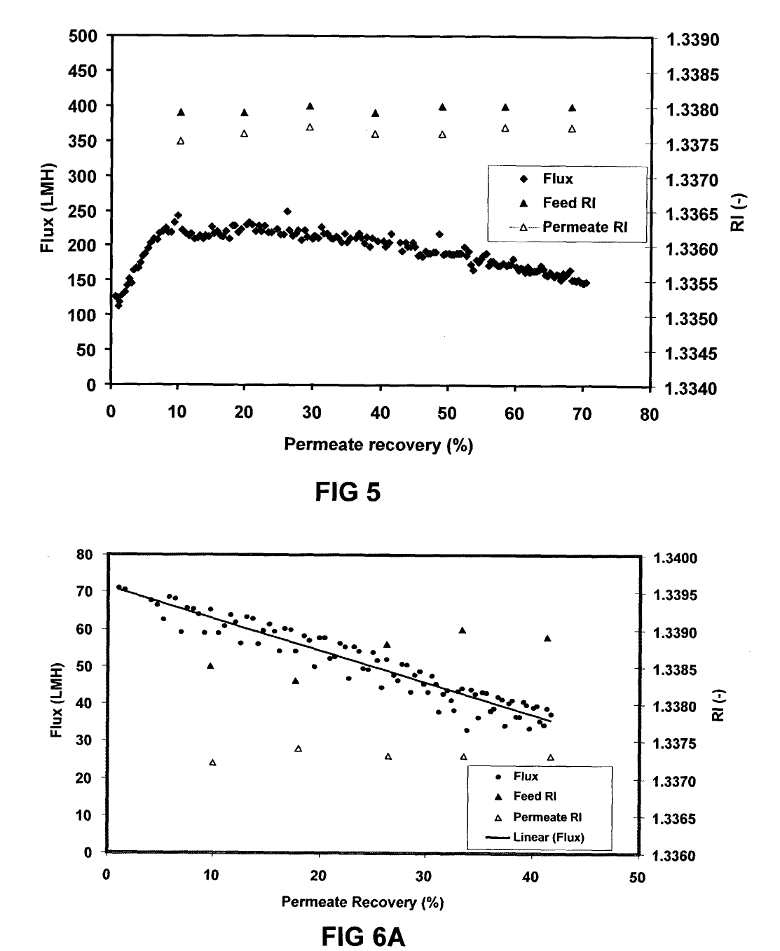

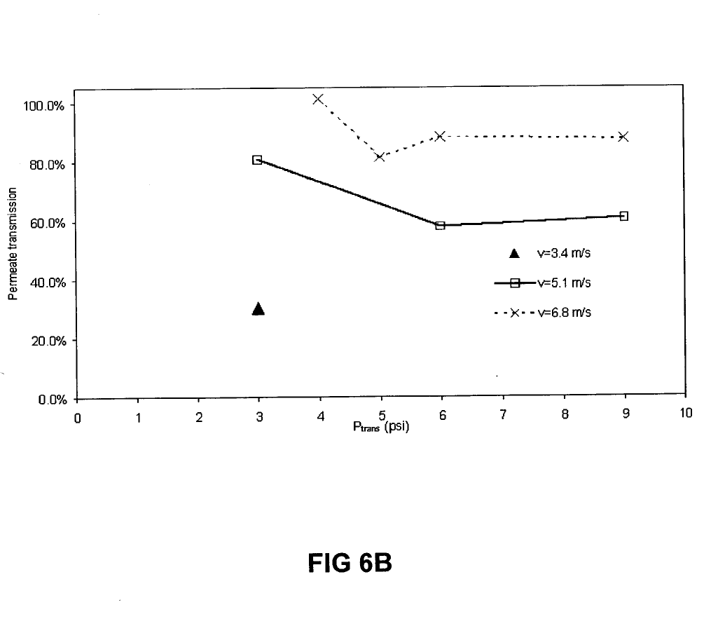

The influence of hydraulic oil contamination was also investigated, at a transmembrane pressure of 4 psi and a tangential flow velocity of 7 m/s. FIGS. 5 and 6A provide results of an experiment with two levels of hydraulic oil contamination. In FIG. 5, a SSMWF with 0.5% hydraulic oil was processed under permeate recovery mode. The flux as a function of permeate recovery decreases slowly from about 230 LMH to about 150 for about 70% recovery, suggesting a weak dependence on hydraulic oil concentration over this range. FIG. 6A shows the flux dependence on permeate recovery for a SSMWF contaminated with 5% hydraulic oil. At a 50% permeate recovery, the concentration of hydraulic oil should be 10% assuming 100% hydraulic oil retention. The flux during this run decreased from a value of 70 LMH to about 30 LMH. The results suggest that an acceptable flux could be obtained even with high hydraulic oil concentration. Moreover, the microfiltration process was not prematurely fouled by the additional hydraulic oil. In spite of several runs using hydraulic oil contaminated SSMWF no major fouling problems were noted. The water rinsing followed by detergent solution wash was sufficient to clean the membrane surface to an adequate degree, while preventing undesired residual formation.

FIG. 6B plots the effect of pressure and cross flow velocity upon the transmission of native microemulsions as observed in a number of runs with a regenerated membrane. The runs all used run using 0.5% hydraulic oil contaminated Clearedge 6510. The graph in FIG. 6B indicates that at velocities >3 m/s, the transmission of the native emulsion drops as pressure is increased. Permeate transmission refers to amount of percentage of original emulsion recovered. Losses of greater than 50% are not technically attractive. A best run on FIG. 6B (velocity of 6.8 m/s and pressure of 4 PSI) achieved near 100% recovery of microemulsions.

Table 2 provides analytical data obtained in a run using 5% hydraulic oil contaminated Clearedge 6510 (FIG. 6A). The data shows almost quantitative emulsion transmittance.

TABLE 2

| Initial solution | | | | | | |
|---|---|---|---|---|---|---|
| is 5% | | | Total Organic | | | |
| Clearedge | Refractive Index | | Carbon | | Sulfonate | |
| 6510 + 5% | | Per- | | Per- | | Per- |
| hydraulic oil | Feed | meate | Feed | meate | Feed | meate |
| 10% Recovery | 1.3385 | 1.3372 | 2.7 | 1.7 | 5100 | 4200 |
| 20% Recovery | 1.3383 | 1.3374 | 2.9 | 1.8 | 5100 | 4800 |
| 30% Recovery | 1.3388 | 1.3373 | 3.0 | 1.8 | 5200 | 4700 |
| 40% Recovery | 1.3390 | 1.3373 | 3.3 | 1.8 | 5300 | 4500 |
| 50% Recovery | 1.3389 | 1.3373 | 3.5 | 1.8 | 5400 | 4700 |
| Clearedge 5% | | 1.3374 | | 2.0 | | 4300 |
| Control | | | | | | |

As is clearly seen, the total organic carbon continues to increase, indicating an increase in hydraulic oil contaminant while that of the permeate remains constant. This is further supported by the increase in RI of the feed from 1.3385 to 1.3389 while that of the permeate is close to that of the control. The sulfonate value of the permeate is slightly higher than that of the control reflecting some augmentation from the sulfonate in hydraulic oil. This is not prejudicial to the functionality of the coolant.

Removal of Bacteria and Endotoxin

Pseudomonas is the most widely found organism in metal working fluids. We therefore conducted experiments to test for its removal. A commercial mixed culture of Pseudomonas spp (Munox XL, Osprey Biotechnics, Fl) was used as inoculum. The use of a commercial culture was preferred for robust experimental control. The culture was grown in both a 1% and 5% Castrol Clearedge 6510 solution supplemented with 0.08% nutrient broth. The 5% concentration did not support sufficient growth to investigate the effect of filtration performance at high bacterial concentrations. Moreover, attempts to spike a 5% SSMWF solution with bacteria grown in 1% SMWF was also not successful as rapid bacterial death resulted. The 1% solution supported vigorous bacterial growth and was ideally suited for investigating the effect of varying bacterial concentration. Bacteria grown in 1% SSMWF could be added to fresh 1% SSMWF without rapid die-off. For these reasons, the inocolum grown in 1% SSMWF was used to spike bacteria free 1% SSMWF to achieve varying amounts of bacterial contamination. These tests present the most challenging condition for bacterial retention due to a combination of low fouling conditions and high bacterial concentration.

Bacterial concentration was determined by plating. Water used for dilution was also plated as control. Samples were diluted serially from 10⁰ to 10⁻⁶ and plated in duplicate. Only results from plates with 30-300 colonies are reported.

The microfiltration runs were initiated on a 1% SSMWF spiked with bacteria at levels of 10² to 10⁴ cfu/mL. Filtration was operated in permeate recovery mode. Typically, 50% of the initial volume was recovered as filtrate. At this point, additional 1% SSMWF was added to restore original feed volume along with additional bacteria culture to achieve a higher bacterial concentration. Filtration proceeded in this mode with increasing bacterial concentration until flux had declined to low values.

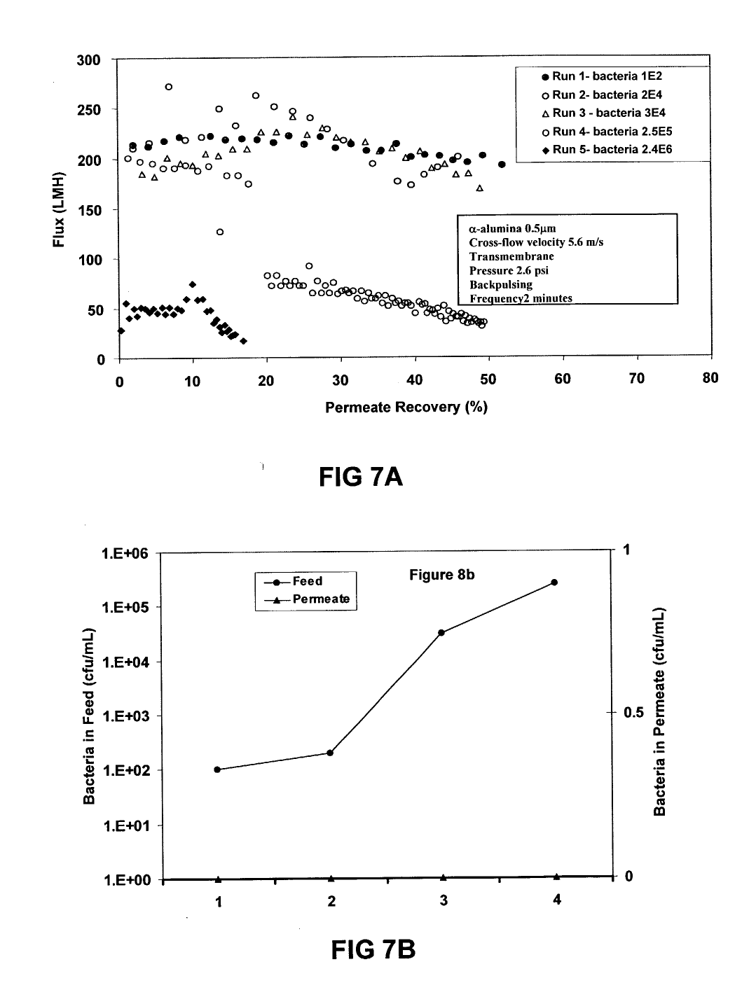

An initial experiment confirmed that the nutrient broth did not cause any fouling of the membrane. Moreover, the flux of a 1% SSMWF at 2.6 psi and a tangential flow velocity of 5.63 m/s was found to be approximately 200 LMH. FIG. 7A presents the flux results for a 1% SSMWF spiked with varying amounts of bacteria. At low bacterial concentrations (10² cfu/mL), the flux is close to that of a 1% SSMWF, decreasing at higher bacterial concentration. The most drastic decline occurs after the bacterial concentration increases to 10⁵ cfu/mL. However, the drastic fall-off is not immediate but occurs only after a prolonged overnight period during which permeate was recycled. FIG. 7B presents the results of the bacterial analysis of the feed and permeate. As seen, the microfiltration removes the bacteria completely, confirming the ability of the process to achieve 6 log bacterial reduction.

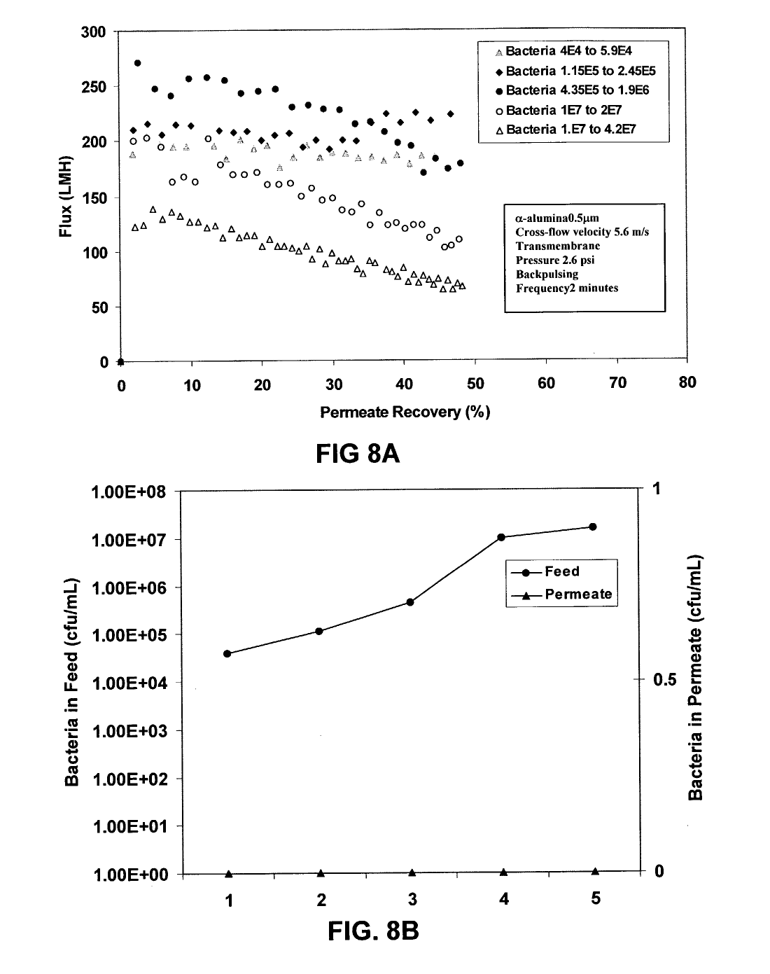

FIGS. 8A and 8B represent additional runs under similar conditions as FIG. 7A. As seen in FIG. 8A, the flux under these conditions appears to decline more gradually and is higher than those seen in FIG. 7A even though the bacterial concentration is higher. This suggests that the flux correlation with bacterial concentration is not very strong.

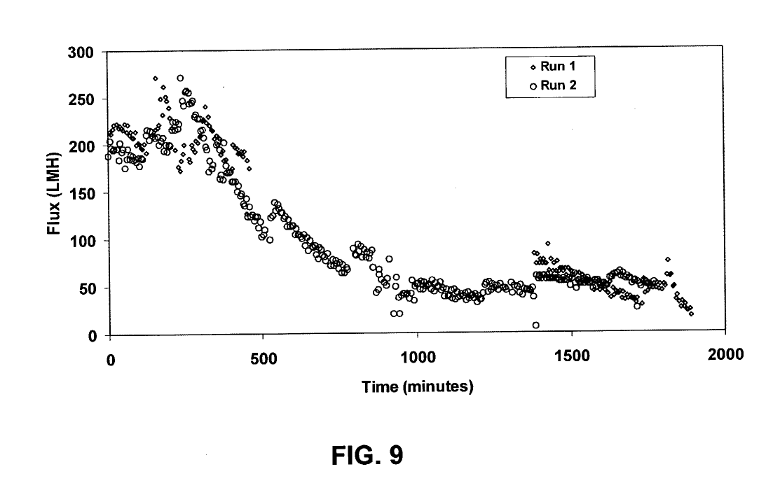

This led us to recast the data in terms of run time (time during which permeate was being withdrawn), as seen in FIG. 9. It is apparent that very good correlation between flux and run time is obtained suggesting that the flux decline is due to a kinetic process associated with bacterial fouling. FIG. 8B represents the relationship between bacterial concentration in feed and in permeate, again confirming that bacterial retention is complete and a minimum of 7 log reduction is feasible.

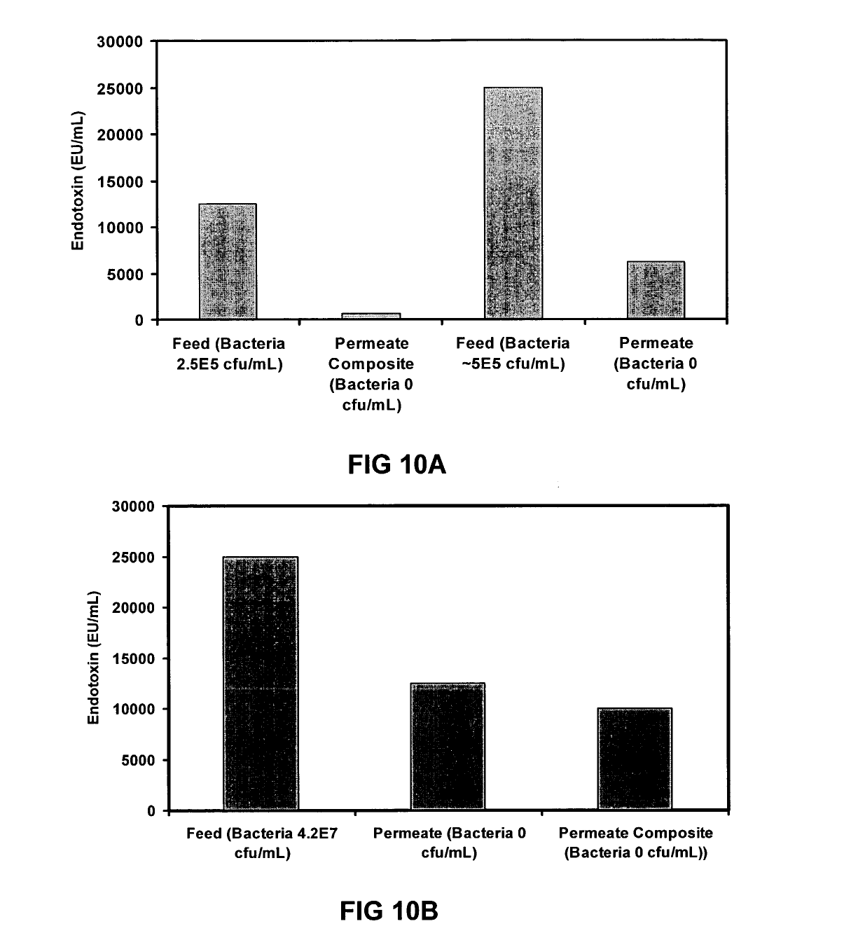

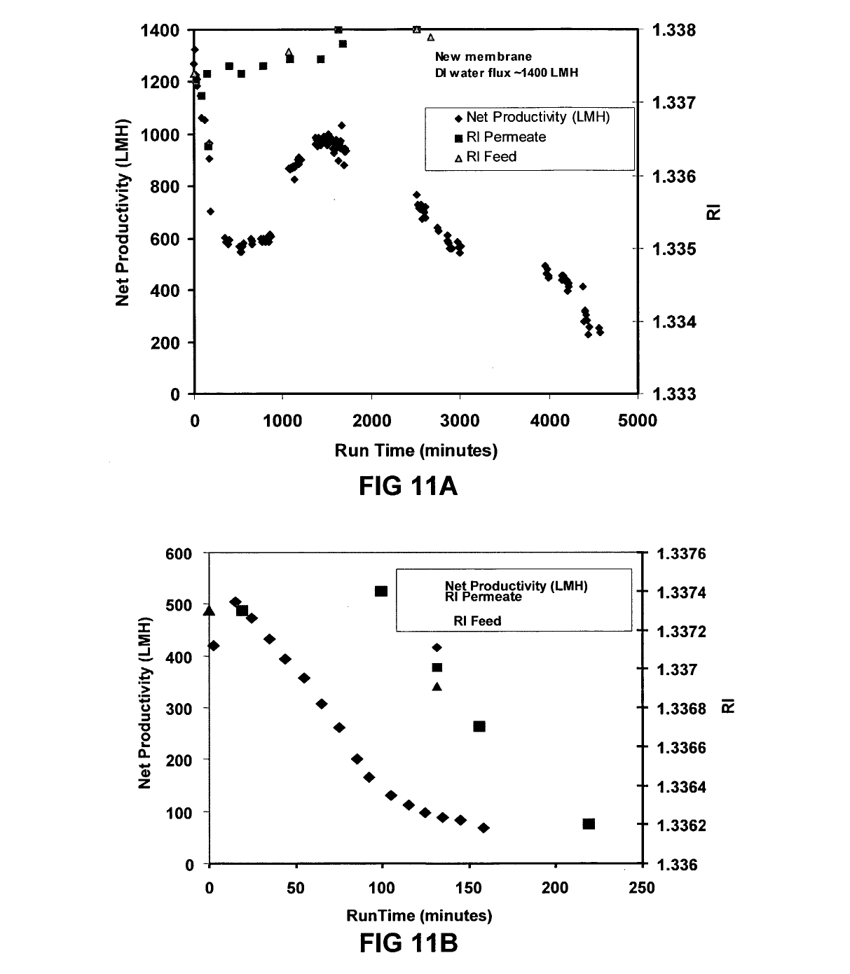

FIGS. 10A and 10B present endotoxin data of the feed and permeate at select points of the FIGS. 8A and 8B runs. The analysis was carried out by gel-clot test at Associates of Cape Cod, Mass. As seen in FIG. 10A, the endotoxin content associated with 2.5E5 cfu/mL is reported as 12,500 EU/mL and the value for a corresponding sample of composite permeate 625 EU/mL. As filtration proceeds, a second sample with double the bacterial level (5E5 cfu/mL) is seen to have an endotoxin content of 25,000 EU/mL. The corresponding permeate endotoxin content is 6,250 EU/mL. In FIG. 11 B, a feed sample with a bacteria content of 4.2E7 cfu/mL was reported to have an endotoxin content of 25,000 EU/mL. The corresponding permeate with no bacterial content had an endotoxin content of 12,500 EU/mL. The permeate composite for the entire run had an endotoxin content of 10,000 EU/mL. These results are summarized in Table 3.

TABLE 3

| | | | Reduction % |
|---|---|---|---|
| | | | (1- |
| Sample ID | Feed | Permeate | permeate/Feed)*100 |
| | 12,500 | 625 (permeate | 95% |
| Feed bacteria | | composite) | |
| 2.5E5 cfu/ml | | | |
| Permeate | | | |
| composite 0 | | | |
| cfu/mL | | | |
| FIG 9a | 25,000 | 6,250 | 75% |
| Feed bacteria 5E5 | | | |
| cfu/ml | | | |
| Permeate 0 cfu/mL | | | |
| | 25,000 | 12,500 | 50% |
| Feed (Bacteria | | | |
| 4.2E7 cfu/mL) | | | |
| | | 10,000 | 60% |
| Permeate | | | |
| composite | | | |
| (Bacteria 0 | | | |
| cfu/mL) | | | |

It is clear that significant endotoxin removal is achieved by preferred embodiment methods of the invention.

Control of Membrane Surface

Experimental results have shown that the invention achieves purification of semi-synthetics. However, successful results are only obtained if water and a detergent such as Dawn @ 2% concentration is used for cleaning. Cleaning is done at the termination of a run during a period when the purification operation is off-line. Back pulsing may be used during cleaning. If cleaning instructions provided by the manufacturer are followed, one would use a combination of high base and oxidant (sodium hydroxide 2%+sodium hypochlorite), followed by high base solution (2% sodium hydroxide) and finally a high acid solution (2% nitric acid). Under these conditions, severe membrane fouling is experienced. Accordingly, in a membrane cleaning cycle, methods of the invention use mild water based detergents.

FIG. 11A shows a run of 5% semi synthetic microemulsion with a new membrane. During this run the flux was maintained quite high at about 200 LMH and emulsion transmittance was complete. A subsequent run (FIG. 11B) followed after cleaning with high base and high acid solution. As seen, there is an immediate drop in flux and the transmittance of the semi-synthetic emulsion is lowered considerably (RI of 1.3362 as opposed to the control value of 1.3374) to a point where the process becomes unattractive.

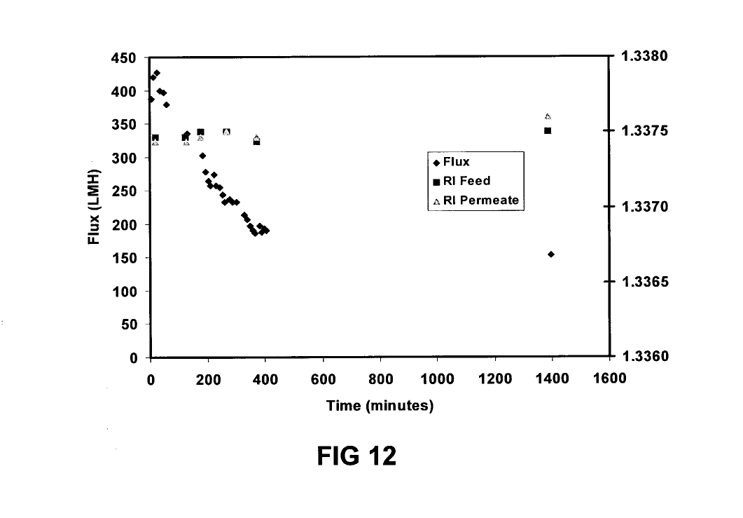

FIG. 12 shows a method for regenerating a fouled surface by treatment with a cationic polymer such as Busan 77 at concentrations of 0.01% to 0.1% followed by activation with 2% sodium hydroxide and 2% nitric acid. A water rinsing precedes the treatment with the cationic polymer and activation agent. The use of this regeneration protocol restores both membrane flux and allows for very good emulsion transmittance. This permits restoration of a membrane surface that has even been fouled severely by metalworking fluid by treatment with a cationic polymer.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A method of purifying semi-synthetic microemulsions, the method comprising steps of:
providing a tangential filter flow path for the microemulsions to tangentially pass a membrane filter, the membrane filter having a pore size in the range of 0.05-1 μm;
maintaining the microemulsions in a tangential flow through the membrane filter having a tangential flow velocity in the range of 1 m/s-7 m/s; and
maintaining a filtering pressure in the range of 0.05-0.7 bar.

2. The method of claim 1, wherein said step of maintaining maintains a tangential flow velocity in the range of 3 m/s-6 m/s.

3. The method of claim 1, wherein said step of maintaining a filtering pressure maintains pressure in the range of 0.1-0.7 bar.

4. The method of claim 1, further comprising a step of periodically back pulsing the membrane filter at a back pulse frequency in the range of 1 back pulse per minute to 1 back pulse per 45 minutes.

5. The method of claim 4, wherein the back pulse frequency is approximately 1 back pulse per 2 minutes.

6. The method of claim 4, wherein said step of back pulsing back pulses the membrane for a duration in the range of 1 second to 30 seconds per back pulse.

7. The method of claim 6, wherein said step of back pulsing back pulses the membrane for a duration of approximately 1 second.

8. The method of claim 4, further comprising a step of cleaning the membrane during an off-line period with a mild detergent and water solution through the membrane filter.

9. The method of claim 1, wherein said step of maintaining filtering pressure comprises steps of:
monitoring the filtering pressure; and
selectively applying back pressure to the membrane filter to maintain filtering pressure in the range of 0.05-0.7 bar.

10. The method of claim 1, wherein said step of maintaining the microemulsions in a tangential flow comprises steps of:
monitoring the tangential flow velocity; and
selectively adjusting the output of a pump that creates the tangential flow to maintain the tangential flow velocity in the range of 1 m/s-7 m/s.

11. The method of claim 1, further comprising a step of, when the membrane filter becomes irreversibly fouled, regenerating the membrane filter.

12. The method of claim 11, wherein said step of regenerating the membrane filter comprises steps of:
treating the membrane filter with a cationic polymer; and
activating the filter.

13. The method of claim 1 applied to a metal working process using a semi-synthetic microemulsion.

14. The method of claim 1, wherein the membrane filter is selected from the group consisting of alumina, titania, ceramic, metallic, metallic oxides and polymer membrane filters.

15. The method of claim 1, further comprising a preliminary step of reducing the hardness of water content in the microemulsions.

16. The method of claim 15, wherein said preliminary step of reducing the hardness comprises adding a calcium chelant to the microemulsions.

17. A method of purifying semi-synthetic microemulsions, the method comprising steps of:
providing a tangential filter flow path for the microemulsions to tangentially pass through a membrane filter, the membrane filter having a pore size selected to inhibit passage of contaminants and permit passage of mciroemulsions;
maintaining the microemulsions in a tangential flow through the membrane filter having a tangential flow velocity in the range of 1 m/s-7 m/s; and
maintaining a filtering pressure in the range of 0.05-0.7 bar.
